(19) United States
(12) Patent Application Publication
(10) Pub. No.: US 2021/0260619 A1
(43) Pub. Date: Aug. 26, 2021

(54) COATED ABRASIVE ARTICLE AND METHOD OF MAKING THE SAME

(71) Applicant: 3M INNOVATIVE PROPERTIES COMPANY, St. Paul, MN (US)

(72) Inventors: Polly H.R. Keen, Cambridge (GB); Philip S. Hill, Leicestershire (GB)

(21) Appl. No.: 17/261,599

(22) PCT Filed: Aug. 12, 2019
(86) PCT No.: PCT/IB2019/056842

§ 371 Date: Jan. 20, 2021

(30) Foreign Application Priority Data
Aug. 16, 2018 (GB) 1813392.6

(51) Int. Cl. B05D 5/02; B05D 1/28; B24D 11/00; B24D 3/28

(52) U.S. Cl. CPC B05D 5/02; B05D 1/28; B05D 2601/26; B24D 3/28; B05D 2252/02; B24D 11/005

(57) ABSTRACT

A method of making a coated abrasive article, the method comprising: providing a backing, providing a curable abrasive slurry having a homogeneous dispersal of abrasive particles, applying the abrasive slurry to at least part of a major surface of the backing and forming a surface texture in the slurry, wherein the abrasive slurry is capable of maintaining the homogeneous dispersal of abrasive particles and the surface texture in an uncured state.

The present invention relates to coated abrasive articles and methods of making the same. More particularly, it relates to coated abrasive articles having a textured coating comprising an abrasive slurry having a homogeneous dispersal of abrasive mineral.

Coated abrasive articles are commonly used for abrading, grinding and polishing operations in both commercial and industrial applications. These operations are conducted on a wide variety of substrates, including wood, wood-like materials, plastics, fiberglass, metals, enamel surfaces, and painted surfaces. Some coated abrasives can be used in either wet or dry environments. Coated abrasives are frequently used in belt sanding, roll finishing and centerless grinding

In general, these abrasive articles include a paper, fabric or polymeric backing on which abrasive particles are adhered. The abrasive particles may be adhered using one or more tough and resilient binders to secure the particles to the backing during an abrading operation. In a manufacturing process, these binders are often processed in a flowable state to coat the backing and the particles, and then subsequently hardened to lock in a desired structure and provide the finished abrasive product.

In a common construction, the backing has a major surface that is first coated with a “make” coat. Abrasive particles are then deposited onto the make layer such that the particles are at least partially embedded in the make coat. The make layer is then hardened (e.g., crosslinked) to secure the particles. Then, a second layer called a “size” layer is coated over the make layer and abrasive particles and also hardened. The size layer further stabilizes the particles and also enhances the strength and durability of the abrasive article. Optionally, additional layers may be added to modify the properties of the coated abrasive article.

The make coat is typically hardened either by thermal-curing or ultraviolet-curing. Ultraviolet (UV) curing has the advantage of being rapid but can carry an increased cost of manufacture. Thermal-curing takes longer but can deliver a more cost effective manufacturing process.

A coated abrasive article can be evaluated based on certain performance properties. First, such an article should have a desirable balance between cut and finish—that is, an acceptable efficiency in removing material from the workpiece, along with an acceptable smoothness of the finished surface. Second, an abrasive article should also avoid excessive “loading”, or clogging, which occurs when debris or swarf become trapped between the abrasive particles and hinder the cutting ability of the coated abrasive. Third, the abrasive article should be both flexible and durable to provide for longevity in use.

It is recognized that the alignment of the abrasive mineral can be key to achieving the desired cut and finish. Such alignment is ensured in the UV curing process by curing the make coat immediately, or at the very least shortly after, the mineral is applied to the make coat. However, maintaining alignment of the mineral during the thermal-curing process is more problematic due to the considerably longer period of time that the mineral is supported by the make coat before the coat hardens.

In the known process described above, the lower end of the abrasive mineral is retained in the top of the make layer with the middle of the abrasive mineral being retained by the size layer. The active part of the mineral (that part which acts on the object to be abraded) is therefore exposed. During the abrading process the abrasive mineral is abraded along with (albeit at a slower rate than) the object to the point where the coated abrasive article no longer achieves the desired cut and finish. At this point the coated abrasive article is considered to have reached the end of its life. This is primarily due to the fact that the exposed layer of abrasive mineral has been “flattened off” to such an extent that it loses its efficacy. Since there are no further layers of abrasive mineral to continue the abrasion process, the abrasive articles has reached the end of its life.

As a potential solution to the problems set out above it is known to provide an abrasive slurry which has abrasive mineral dispersed throughout the slurry. In WO2006/112909, for example, an abrasive slurry is applied to a backing, the slurry partially cured, mechanically pressed by embossing to provide a contoured surface and then secondary cured to generate the finished abrasive article.

The slurry of WO'909 has insufficient mechanical stability to have the pattern embossed before curing. As a result, the slurry must be partially cured in order to raise the viscosity of the slurry to a point where it is able to hold the shape embossed by the gravure roller or press. This leads to additional complexity of manufacture and resultant cost.

Furthermore, the pattern to be imparted is generated by mirroring the pattern on the gravure roller or press. Thus, the shape of the pattern achieved is limited to that which can be mechanically pressed into the part-cured slurry.

It is an object of the invention to at least mitigate some of the above problems. According to a first aspect of the invention there is provided a method of making a coated abrasive article, the method comprising:

providing a backing,

providing a curable abrasive slurry having a homogeneous dispersal of abrasive particles,

applying the abrasive slurry to at least part of a major surface of the backing and forming a surface texture in the slurry,

wherein the abrasive slurry is capable of maintaining the homogeneous dispersal of abrasive particles and the surface texture in an uncured state.

It is a significant advantage that the abrasive mineral remains in homogeneous suspension for extended periods of time. That is to say, not only does the slurry maintain its surface texture, but also the abrasive particles remain homogeneously dispersed through the slurry. This is significant as the performance of the resultant abrasive article is maintained after the initial surface texture is abraded during use. This allows the cut and life of the abrasive article to be improved without any detriment to finish.

Further advantageously, the method of the first aspect (and subsequent aspects) of the current invention allows the surface texture to be maintained in the abrasive slurry for extended periods of time without the requirement to immediately set or cure the slurry after forming the surface texture.

It is possible to generate surface texture in known abrasive slurries. However, due to the rheological instability of such slurries, the slurries require ultra-violet (UV) curing immediately after the formation of the surface texture. In the absence of immediate UV curing, known slurries lose their surface texture within seconds. Consequently, known slurries can only be UV-cured since thermal curing takes significantly longer than the short period of time in which the known slurries maintain their surface texture.

The present invention overcomes this problem by providing an abrasive slurry that is capable of maintaining the surface texture for extended periods of time, significantly longer that the period of time required to thermally cure the slurry. This presents significant process advantages. Firstly, the production volume can be increased by the use of thermal curing as opposed to UV curing. Secondly, the stability of the slurry allows for significantly increased manufacturing flexibility since the requirement to cure immediately after texture formation is eliminated. Thirdly, the energy requirements for producing the abrasive article are reduced as there is no longer the requirement to use energy-intensive UV curing.

The above advantage is achieved by the slurry displaying sufficient shear thinning to allow surface texture features to be formed via film splitting with precise definition but sufficiently high yield stress to hold shape for a sufficiently long period of time to eliminate the requirement for immediate UV curing. The abrasive slurry of the present invention is the first to display a combination of such properties and as a result the first to display the significant advantages set out above.

According to a second aspect of the invention there is provided a coated abrasive article comprising:

a backing having first and second opposed major surfaces;

a cured abrasive slurry disposed on the first major surface of the backing, wherein the cured abrasive slurry has a textured major surface opposite the backing, wherein the textured major surface comprises a first interconnected network of interconnected first ridges, wherein at least some of the interconnected first ridges meet at first intersection points, and wherein outwardly extending first spikes are disposed proximate to at least a portion of the first intersection points.

According to a third aspect of the invention there is provided a coated abrasive article comprising:

a backing having first and second opposed major surfaces;

a textured coating disposed on the first major surface of the backing, wherein the textured coating has a textured major surface opposite the backing, wherein the textured major surface comprises a network of ridges arranged in a herringbone pattern.

According to a fourth aspect of the invention there is provided a coated abrasive article comprising:

a backing having first and second opposed major surfaces;

a textured coating disposed on the first major surface of the backing, wherein the textured coating has a textured major surface opposite the backing, wherein the textured major surface comprises a plurality of discreet depositions of abrasive slurry.

Advantageously, the fourth aspect of the invention delivers discrete depositions of abrasive slurry which have sharp side walls which improves cut and finish as well as increasing the flexibility of the coated abrasive article.

The invention will now be described with reference to the following drawings, in which:

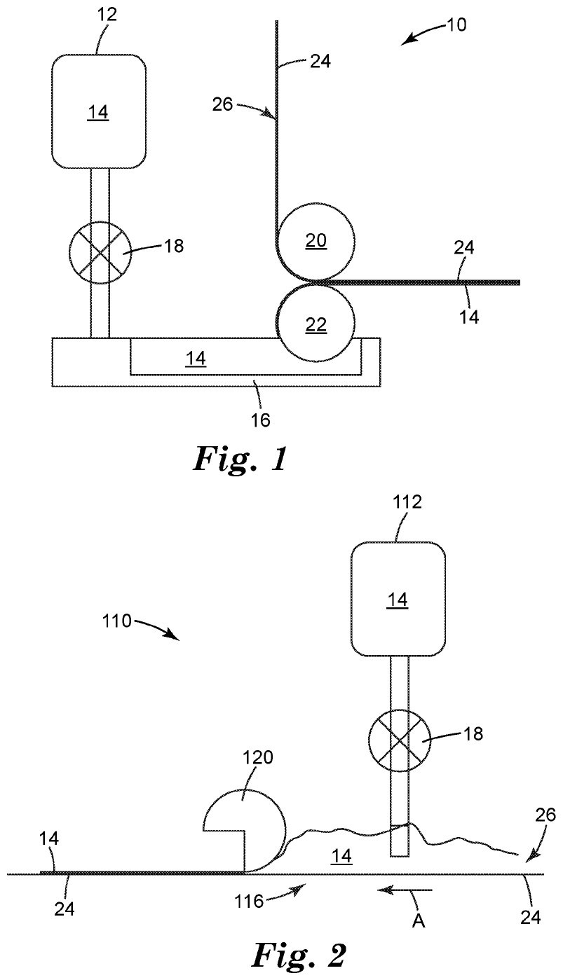

FIG. 1 is a schematic view of first manufacturing line for implementing a method of manufacturing an abrasive article according to the present invention;

FIG. 2 is a schematic view of second manufacturing line for implementing a method of manufacturing an abrasive article according to the present invention;

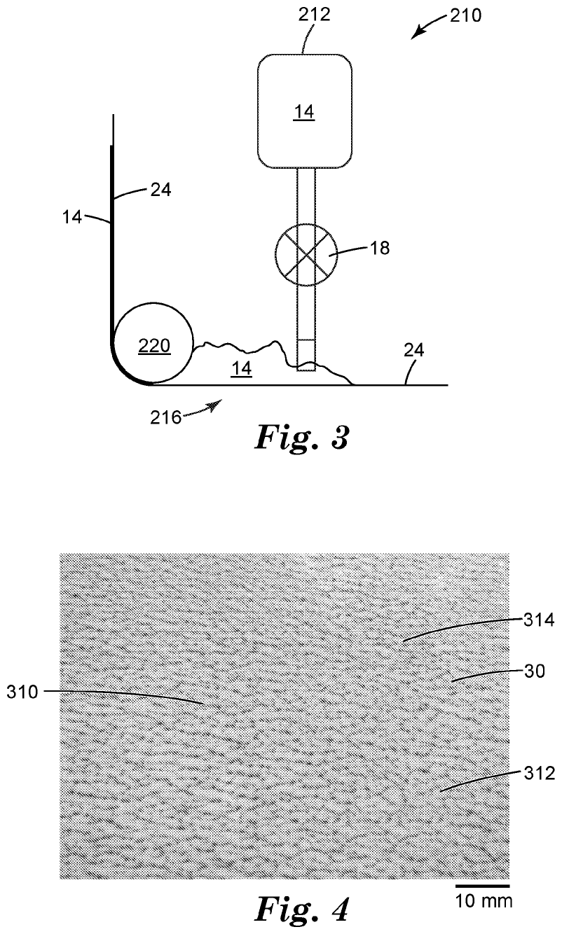

FIG. 3 is a schematic view of third manufacturing line for implementing a method of manufacturing an abrasive article according to the present invention;

FIG. 4 is an image of a coated abrasive article according to the present invention manufactured using the forward rolling method of manufacture shown in FIG. 3;

FIG. 5 is an image of an alternative coated abrasive article according to the present invention manufactured using the forward rolling method of manufacture shown in FIG. 3;

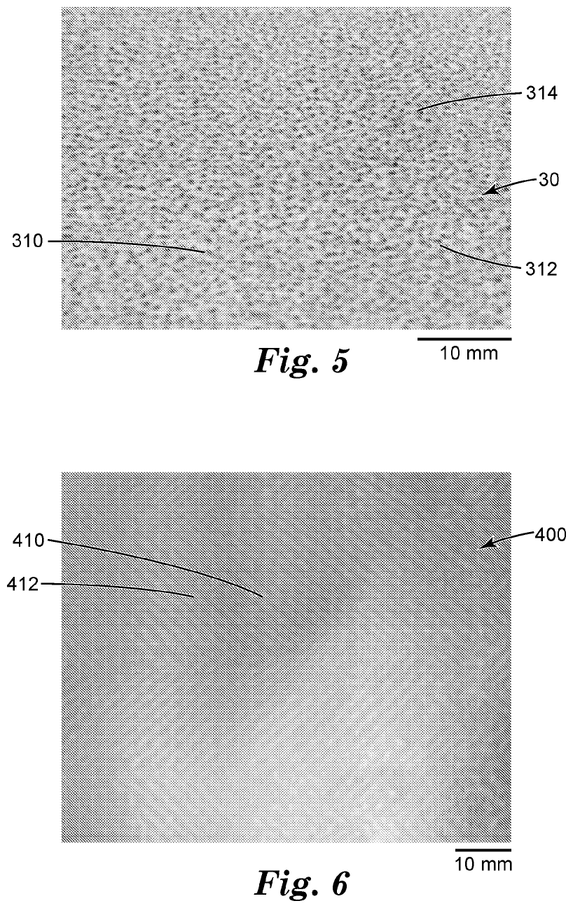

FIG. 6 is an image of a coated abrasive article according to the present invention manufactured using the reverse rolling method of manufacture shown in FIG. 3;

FIG. 7 is an image of an alternative coated abrasive article according to the present invention manufactured using the reverse rolling method of manufacture shown in FIG. 3;

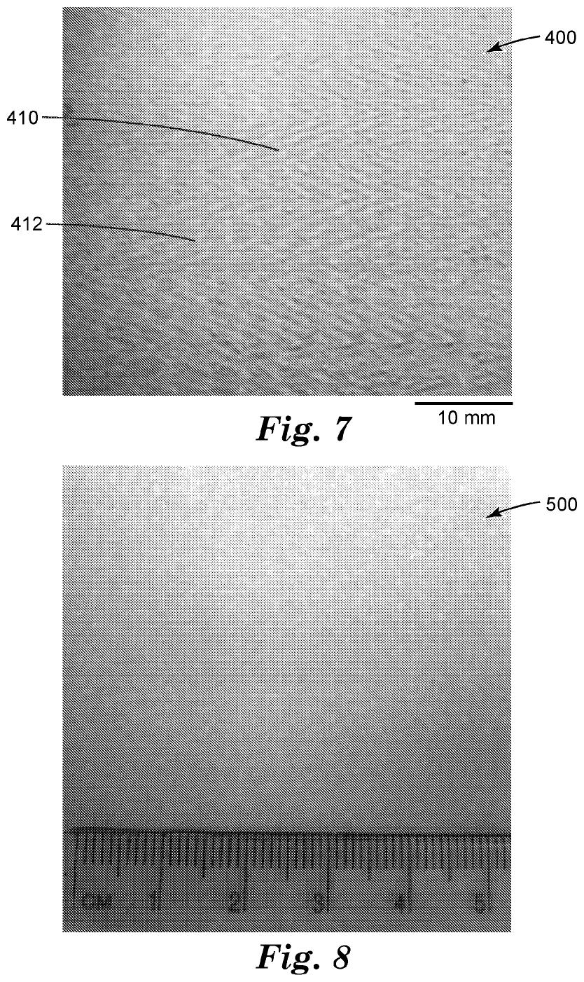

FIG. 8 is an image of a coated abrasive article according to the present invention manufactured using the knife coating method of manufacture shown in FIG. 2; and

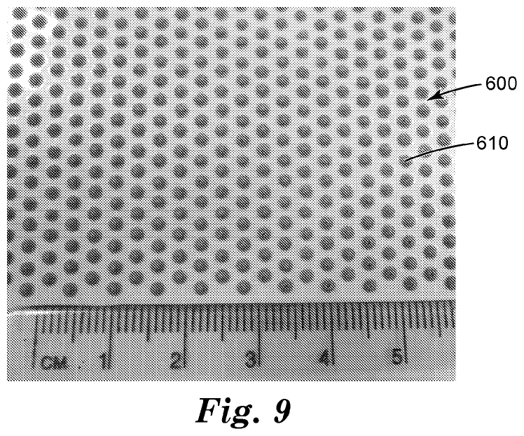

FIG. 9 is an image of a coated abrasive article according to the present invention manufactured using a screen printing method of manufacture.

Turning to FIG. 1 a roll coating manufacturing line 10 is shown having a slurry tank 12 which contains a bulk volume of a pre-mixed abrasive slurry 14 as will be described in further detail shortly. The slurry tank 12 feeds abrasive slurry 14 to a slurry basin 16 via an optional pump 18. It will be appreciated that the pump 18 may not be needed in instances where the slurry 14 may be fed to the slurry basin 16 by a gravity feed. A first calendar roller 20 is rotated in an anti-clockwise direction so as to pull an abrasive backing sheet 24 therebetween and around a 90 degree chord of the first calendar roller 20. A second calendar roller 22 is partially submerged within abrasive slurry 14 contained within the slurry basin 16 and is rotated in a clockwise direction so as to entrain a volume of abrasive slurry 14 onto the surface of the roller 22 and into contact with a first surface 26 of the abrasive backing sheet 24. In such a manner, abrasive slurry is deposited onto the abrasive backing sheet 24 for subsequent curing (not shown in FIG. 1 for clarity) to form an abrasive sheet 30. The distance between the rollers 20, 22 is set dependent on the volume of slurry to be deposited onto the backing sheet 24. After curing by a known method, the abrasive sheet 30, is wound onto drums and may be converted into a range of abrasive articles in the form of, for example, belts, sheets or discs.

FIG. 2 shows a knife coating manufacturing line 110 for the production of abrasive articles. The line 110 is shown has a slurry tank 112 which contains a bulk volume of a pre-mixed abrasive slurry 14 as will be described in further detail shortly. The slurry tank 112 feeds abrasive slurry 14 to a slurry table 116 via an optional pump 18. It will be appreciated that the pump 18 may not be needed in instances where the slurry 14 may be fed to the slurry basin 16 by a gravity feed. Passing over the slurry table 116 is a continuous line of abrasive backing sheet 24 onto which is deposited the abrasive slurry 14 by the pump 18 or gravity feed. The movement of the abrasive backing sheet 24 over the table 116 entrains a volume of abrasive slurry 14 which is moved, along with the abrasive backing sheet 24, towards a doctor blade, or knife 120 in the direction of arrow A. The knife 120 creates a choke point for the flow of slurry 14 causing a consistent thickness of abrasive slurry 14 to be drawn under the knife 120 and laid on to the onto a first surface 26 of the abrasive backing sheet 24. The distance between the first surface 26 of the abrasive backing sheet 24 and a lower edge 122 of the knife 120 is set dependent on the volume of slurry to be deposited onto the backing. After curing, the abrasive sheet 30, is wound onto drums and may be converted into a range of abrasive articles in the form of, for example, belts, sheets or discs.

FIG. 3 shows an alternative roll coating manufacturing line 210 for the production of abrasive articles. The line 210 is shown has a slurry tank 212 which contains a bulk volume of a pre-mixed abrasive slurry 14 as will be described in further detail shortly. The slurry tank 212 feeds abrasive slurry 14 to a slurry table 216 via an optional pump 18. It will be appreciated that the pump 18 may not be needed in instances where the slurry 14 may be fed to the slurry basin 16 by a gravity feed. Passing over the slurry table 216 is a continuous line of abrasive backing sheet 24 onto which is deposited the abrasive slurry 14 by the pump 18 or gravity feed. The movement of the abrasive backing sheet 24 over the table 216 entrains a volume of abrasive slurry 14 which is moved, along with the abrasive backing sheet 24, towards a calendar roller 220. The calendar roller 220 may be driven clockwise (forward rolling), anticlockwise (reverse rolling) or be free rolling depending on the nature of the abrasive topology to be generated. As the abrasive backing sheet 24 rotates around the calendar roller 220, slurry is deposited onto the backing sheet 24 ready for subsequent curing. After curing the abrasive sheet 30, is wound onto drums and may be converted into a range of abrasive articles in the form of, for example, belts, sheets or discs.

The effect of the roll coating or knife coating is to produce in the surface of the abrasive slurry 14 a topology that delivers particular performance benefits to the abrasive article produced. That topology is delivered by two primary factors. Firstly, the physical interaction of the slurry with the surface of the rollers 20, 22 or 220 or knife 120, by virtue of the rollers 20. 22 or 220 or knife 120 pulling the surface of the slurry 14 in a direction away from the first surface 26 of the abrasive backing sheet 24 to form a surface texture and, secondly, by the rheological properties of the slurry 14.

Addressing surface texture by reference to FIGS. 4 and 5, the topology of a cured abrasive sheet 30 manufactured using the forward rolling method of manufacture of FIG. 3 is shown with a series of ridges indicated at 310 and troughs indicated at 312. The ridges 310 are interconnected and meet at intersection points which define outwardly extending spikes indicated by way of example at 314.

Referring now to FIGS. 6 and 7, the topology of a cured abrasive sheet 400 manufactured using the reverse rolling method of manufacture of FIG. 3 is shown with a series of ridges indicated at 410 and troughs indicated at 412. It will be noted that the ridges 410 and troughs 412 form a herringbone pattern.

Accordingly, the cured slurry 14 of FIGS. 4 to 7 has formed a surface texture which can be varied dependent on nature of the manufacturing technique used to manufacture the abrasive sheet. Importantly, across each of the abrasive sheets shown in FIGS. 4 to 7, the slurry 14 holds the surface texture following the establishment of that texture by interaction with the rollers 20, 22 or 220 and prior to the curing of the slurry by UV curing or other known method.

The formation (by the pulling of the surface of the slurry 14 by the rollers 20, 22 or 120 of the small sharp ridges and peaks shown in FIGS. 4 to 7 lead to improved abrasive performance in terms of both cut and finish over known abrasive articles as will be described further shortly.

Turning now to FIG. 8 which shows an image of the topology of a cured abrasive sheet 500 manufactured using the knife rolling method of manufacture of FIG. 2. Whilst this process of manufacture does not generate the topological features associated with the screen splitting achieved by the rolling methods, it nonetheless delivers an abrasive sheet with homogeneity of mineral throughout the slurry.

FIG. 9 shows an image of the topology of a cured abrasive sheet 600 manufactured using the process of screen printing in a known manner to produce a textured surface comprising a plurality of discreet depositions 610 of abrasive slurry.

Returning to the rheological performance of the slurry, and without wishing to be bound by a particular theory, it is presented that several characteristics of the non-Newtonian behaviour of the slurry 14, lead to maintenance of the surface texture shown in FIGS. 4 to 9. The key rheological characteristics are: a high degree of pseudoplasticity (shear thinning), low thixotropy and the possession of a yield stress. The rheological properties of the slurry are affected by the introduction of a rheology modifier such as an organically modified clay, for example Garamite, a fumed silica or a nano-cellulose.

The roles of these rheological characteristics, as affected by the rheology modifier, within the texture-generating coating process are described henceforth. As the uncured slurry 14 passes between the rollers 20 and 22, it experiences a shear force. Because of the high pseudoplasticity of the slurry, the shear force causes the viscosity of the slurry to be significantly reduced. The roll-coating phenomenon of film-splitting occurs between the backing surface 26 and the roller surface 22 as the slurry exits the nip between the rollers. The low viscosity of the slurry at the nip results in particularly sharp spikes as the film of slurry splits. The property of low thixotropy means that the viscosity of the slurry increases rapidly after the cessation of a shear force when the slurry exits the rollers in its spiked film-split texture. Therefore the sharp spikes of the slurry on the backing surface 26 do not collapse. The slurry's yield stress retains the spiked texture and preserves the homogenous suspension of abrasive mineral throughout the textured slurry prior to curing.

The above combination of rheological properties in an abrasive slurry provides a slurry which will flow sufficiently readily to permit the pulling of sharp peaks by film splitting, but which also has a sufficiently high yield stress to prevent those peaks collapsing before such time as they can be fixed by curing. Furthermore, and of critical importance to the life of the abrasive article is the ability of the slurry to retain the abrasive particles in homogenous dispersal throughout the slurry prior to curing.

Whilst it will be appreciated that the abrasive slurry disclosed herein is capable of supporting any size of mineral grain, Examples 1 and 2 of slurries containing P1200 and P180 grit, respectively, will now be set out in detail.

### EXAMPLE 1

The formulation of the slurry of Example 1.1 is set out in Table 1 below.

TABLE 1.1

| Constituent | Weight % |
|---|---|
| Urea Formaldehyde resin | 25.00% |
| Garamite 1958 | 2.00% |
| Diamine Phospate hardener | 2.50% |
| Latex (Vinamul 9300) | 3.00% |
| BYK 190 | 0.14% |
| BYK 420 | 0.14% |
| Water | 17.22% |
| Aluminium Oxide Abrasive Mineral | 50.00% |
| (P1200 BFRPL) | |

Table 1.2 below shows the rheological properties of the above formulation prior to curing.

The trace shown in Table 1.2 is from a ramp up, hold at high shear, ramp down test on a cone and plate rheometer with a 100 μm gap and a 35 mm 2° cone. The shear rate is ramped up to 1000 s⁻¹, held at 1000 s⁻¹ for 30 s, the ramped down to 0 s⁻¹. The key characteristics of the fluid are the pseudoplasticity (shear thinning), and the yield stress of the slurry.

The slurry described above was knife-coated, “spiked” by forwards rolling, or “herringboned” by reverse rolling. The textured slurry was cured thermally in an oven at 75° C. for 1 hr.

The performance of the resulting textured slurry abrasive was tested using a rocking drum tester to grind a 1 cm² square section mild steel bar. Lubrication on each abrasive sample was 3 drops of mineral oil. The test was split into multiples of 50 strokes of the test piece against the coated abrasive. After each 50-stroke duration, the cut (stock removal) in g and surface finish (Rz) in microns of the steel were recorded. The steel was then subjected to 50 strokes onto 3M 272L (40 μm) so that the surface finish of the bar was consistent before a test sample of abrasive was used. The testing on the abrasive sample was repeated 3 times until the abrasive had been subjected to 150 strokes. The control abrasive for comparison was 3M 272L (15 μm) (an electrocoated product).

Referring to Table 1.3 below, RD (50 strokes) refers to the stock removal (g) from the steel bar after 50 strokes against the abrasive sample.

As can be seen from Table 1.3 the abrasive articles of Example 1 display improved cut and life over the electrocoated control.

### EXAMPLE 2

The formulation of the slurry of Example 2 is set out in Table 2.1 below.

TABLE 2.1

| Constituent | Weight % |
|---|---|
| PF resin | 25.72% |
| Byk R605 | 1.00% |
| Hydrosil 1151 | 1.98% |
| MW50 | 20.54% |
| Water | 7.83% |
| P180 BFRPL | 41.28% |
| Garamite 1958 | 1.65% |

Table 2.2 below shows the rheological properties of the above formulation prior to curing.

The trace shown in Table 2.2 is from a ramp up, hold at high shear, ramp down test on a cone and plate rheometer with a 100 μm gap and a 35 mm 2° cone. The shear rate is ramped up to 1000 s⁻¹, held at 1000 s⁻¹ for 30 s, the ramped down to 0 s⁻¹. The key characteristics of the fluid are the pseudoplasticity (shear thinning) and the yield stress of the slurry at low shear rate.

The slurry was knife-coated and “spiked” by forwards rolling. The textured slurry was subsequently cured thermally in an oven at 107° C. for 240 mins.

The performance of the textured slurry abrasives was tested using a rocking drum tester to grind a 1 cm² square section stainless steel bar. Lubrication on each abrasive sample was 5 drops of water after every 50 passes. The test was split into multiples of 50 passes of the test piece against the coated abrasive for the first 1000 passes and thereafter split into multiples of 100 passes to a final total of 5000 passes or the point at which the abrasive was deemed to have run its course such that the backing became visible causing the steel rod to judder and/or the cut rate dropped to less than 25% of its starting cut rate, whichever came soonest. After each 50 pass duration (100 passes beyond 1000), the cut (stock removal) in grams of the steel was recorded as shown in Table 2.3 below. The control abrasive for comparison was VSM KK718X in grade P180.

As can be seen from Table 2.3 the abrasive articles of Example 2 displays improved cut and life over the electrocoated control.

1. A method of making a coated abrasive article, the method comprising:
providing a backing,
providing a curable abrasive slurry having a homogeneous dispersal of abrasive particles,
applying the abrasive slurry to at least part of a major surface of the backing and forming a surface texture in the slurry,
wherein the abrasive slurry is capable of maintaining the homogeneous dispersal of abrasive particles and the surface texture in an uncured state.

2. The method of claim 1 wherein the step of applying the abrasive slurry comprises coating the slurry onto the backing and forming the texture in the abrasive slurry.

3. The method of claim 2 wherein coating the slurry onto the backing and forming the texture in the slurry are performed contemporaneously by rolling the slurry onto the backing.

4. The method of claim 2 wherein coating the slurry onto the backing and forming the texture in the slurry are performed sequentially by:
a) knife coating or roll coating the slurry onto the backing, and
b) rolling the coated slurry to form the texture, respectively.

5. The method of claim 2 wherein coating the slurry onto the backing and forming the texture in the slurry are performed contemporaneously by screen printing or stencil printing.

6. The method of claim 2 wherein coating the slurry onto the backing and forming the texture in the slurry are performed contemporaneously by rotogravure.

7-11. (canceled)

12. The method of claim 1, wherein the abrasive slurry comprises a thermoset resin binder.

13. The method of claim 12, wherein the abrasive slurry further comprises a rheology modifier.

14. The method of claim 13, wherein the rheology modifier comprises one of an organically modified clay, fumed silica or nano-cellulose.

15. The method of claim 1, the method further including the step of:
at least partially curing the slurry to provide the textured coating after applying the abrasive slurry to at least part of a major surface of the backing.

16. A coated abrasive article comprising:
a backing having first and second opposed major surfaces;
a cured abrasive slurry disposed on the first major surface of the backing, wherein the cured abrasive slurry has a textured major surface opposite the backing, wherein the textured major surface comprises a first interconnected network of interconnected first ridges, wherein at least some of the interconnected first ridges meet at first intersection points, and wherein outwardly extending first spikes are disposed proximate to at least a portion of the first intersection points.

17. The coated abrasive article of claim 16, wherein the interconnected first ridges are not arranged according to a predetermined pattern.

18. The coated abrasive article of claim 16, wherein the abrasive particles conform to an abrasives industry specified nominal grade.

19. The coated abrasive article of claim 16, wherein the textured coating comprises a thermoset binder.

20. The coated abrasive article of claim 19, wherein the abrasive slurry further comprises a rheology modifier.

21. The coated abrasive article of claim 20, wherein the rheology modifier comprises one of an organically modified clay, fumed silica or nano-cellulose.

22. A coated abrasive article comprising:
a backing having first and second opposed major surfaces;
a textured coating disposed on the first major surface of the backing, wherein the textured coating has a textured major surface opposite the backing, wherein the textured major surface comprises a network of ridges arranged in a herringbone pattern.

23. A coated abrasive article comprising:
a backing having first and second opposed major surfaces;
a textured coating disposed on the first major surface of the backing, wherein the textured coating has a textured major surface opposite the backing, wherein the textured major surface comprises a plurality of discreet depositions of abrasive slurry.

24. The coated abrasive article of claim 23 wherein the discreet depositions of abrasive slurry have a substantially trapezoidal form in vertical cross-section.
